(19) United States
(12) Patent Application Publication
(10) Pub. No.: US 2025/0233887 A1
(43) Pub. Date: Jul. 17, 2025

(54) METHODS FOR GENERATING A HONEYPOT

(71) Applicant: Robert Bosch GmbH, Stuttgart (DE)

(72) Inventors: Christopher Huth, Heilbronn (DE); Dominik Germek, Berlin (DE); Niclas Ilg, Ammerbuch (DE)

(21) Appl. No.: 19/015,224

(22) Filed: Jan. 9, 2025

(30) Foreign Application Priority Data
Jan. 12, 2024 (EP) 24 15 1626.9

(51) Int. Cl. H04L 9/40

(52) U.S. Cl. CPC H04L 63/1491; H04L 63/1433

(57) ABSTRACT

A method for generating a honeypot. The method includes: sending messages to a target system, observing responses of the target system to the messages, generating, according to the observed responses of the target system, a state machine model for one or more interfaces of the target system, ascertaining, for each one or more known vulnerabilities, a chain of states of the state machine model that, when followed, makes it possible to exploit the vulnerability, removing, for each of the one or more vulnerabilities, at least one state of the chain from the state machine model, and generating a honeypot that responds to messages according to the state machine model.

### FIELD

The present invention relates to a method for generating a honeypot.

### BACKGROUND INFORMATION

The number of networked data processing devices (including embedded devices) is increasing rapidly. An important aspect of all these devices, be they server computers on the Internet or control devices in the automotive or IoT sector, is product security. Honeypots are dummies that imitate such a valuable (target) system in order to attract attackers and gain information about their attack strategies and targets. Honeypots are an established tool for threat analysis, especially in corporate IT, and they are now also used in the area of the (industrial) Internet of Things ((I)IoT). Although honeypots are a very useful tool to complement the cybersecurity strategy, implementing suitable honeypots for the specific need and the particular target system requires a lot of manual work by experts.

Approaches that make it easier to provide (in particular configure) a suitable honeypot are therefore desirable.

### SUMMARY

According to various embodiments of the present invention, a method for generating a honeypot is provided, comprising: sending messages to a target system, observing responses of the target system to the messages, generating, according to the observed responses of the target system, a state machine model for one or more interfaces of the target system, ascertaining, for each one or more known vulnerabilities, a chain of states of the state machine model that, when followed, makes it possible to exploit the vulnerability, removing, for each of the one or more vulnerabilities, at least one state of the chain from the state machine model, and generating a honeypot that responds to messages according to the state machine model.

The method described above makes it possible to completely automate the implementation process of a honeypot including its configuration, such as the automatic adoption of the behavior of a specific operating system (e.g., a specific version) from a plurality of different operating systems (versions). For example, it can be used to control and improve the coverage of shell interactions (that are of interest, e.g., are to be monitored).

By means of the state machine model, the honeypot imitates, for example, an operating system including a command line interface and/or an application, a network interface, and/or some kind of API (application programming interface). The method described above thus makes it possible to simulate a complex system environment such as a command line interface (and to automatically adapt it to a target system so that the target system is imitated).

By removing the ascertained system states (hereinafter also referred to as “filtering” of the state machine model), the risk is minimized (or at least significantly reduced) that an attacker abuses the honeypot (e.g., for an attack on a third-party system). Since complex systems tend to give an attacker a more powerful tool, this can prevent an attacker from using the honeypot against third parties. For example, the state machine model is filtered in such a way that it does not affect the attack path of the attacker until third parties are affected (e.g., states that directly pose a threat to third-party systems, e.g., those in which communication with a third-party system takes place, are removed).

Various exemplary embodiments of the present invention are specified below.

Exemplary embodiment 1 is a method for generating a honeypot, as described above.

Exemplary embodiment 2 is a method according to exemplary embodiment 1, wherein, for each of the one or more vulnerabilities, a state is ascertained in the corresponding chain of states and removed from the state machine model, which prevents the vulnerability from being exploited, wherein a state that is as far back as possible in the chain of states (i.e., that requires as many interactions as possible with the honeypot in order to be reached), but, upon reaching of which, damage is not yet caused, is ascertained as the state.

This ensures that an attacker has to or can spend as much time as possible with the honeypot without causing any damage.

Exemplary embodiment 3 is a method according to exemplary embodiment 1 or 2, wherein, for each of the one or more vulnerabilities, a state upon reaching of which communication with a third-party system (i.e., a data processing device other than that of the attacker and that of the honeypot) is carried out is ascertained in the corresponding chain of states and removed from the state machine model.

This prevents third-party systems from being attacked via the honeypot.

Exemplary embodiment 4 is a method according to one of exemplary embodiments 1 to 3, wherein the state machine model is generated by adapting a previously generated other state machine model for another target system according to the observed responses of the target system.

This allows the state machine model to be generated efficiently, in particular when honeypots are generated for various target systems.

Exemplary embodiment 5 is a method according to exemplary embodiment 4, wherein the other state machine model is generated by sending the and/or other requests to the other target system, observing responses of the other target system to the requests or the other requests, and generating the other state machine model according to the observed responses of the other target system.

According to one embodiment, the state machine is thus learned according to a two-stage procedure by first learning a state machine for a “base” target system (i.e., the “other” target system), which state machine is then adapted for the actual target system. The state machine model for the base target system can be adapted for various target systems. It should be noted that, in the general method described above, the “target system” can also refer to the base target system and, in this step, the generation of a honeypot that responds to requests according to the state machine model also includes the step of adapting to the target system. If the actual target system (of the honeypot) and the base target system do not differ significantly (for example, only version numbers or other information that is output are adapted), the honeypot in this interpretation then responds to requests “according to the state machine model” despite the adaptation, but it is then a honeypot for the actual target system and not for the base target system to which the requests were sent.

Since a complex system, such as an operating system shell, is much more extensive than, for example, a network service, it is ascertained according to one embodiment during the adaptation which parts of the honeypot must be closely adapted to the corresponding critical target system and which parts can be adopted from the base version. This reduces the effort of version adaptation and makes it possible to quickly respond to (newly discovered) attacks whose functionality is unknown, or to quickly adapt the honeypot to new (operating system and/or interface) versions.

Exemplary embodiment 6 is a method according to exemplary embodiment 4 or 5, wherein adapting the other state machine model comprises adapting, according to the observed responses of the target system, a version of the one or more interfaces whose behavior is modeled by the other state machine model.

The other state machine model may only need to be modified slightly, for example by supplementing it with special features of the version of the one or more interfaces that the target system provides.

Exemplary embodiment 7 is a method according to one of exemplary embodiments 4 to 6, wherein the other state machine model is selected from a set of other state machine models for the other target system or one or more other target systems on the basis of a check as to whether the other state machine model fulfills functions required for imitating the target system.

Exemplary embodiment 8 is a method according to one of exemplary embodiments 1 to 7, wherein, when generating the state machine model, information about the target system that is to be kept confidential according to a confidentiality criterion is removed from the state machine model.

The state machine model can thus be filtered with regard to confidential information (such as passwords but also operators of the honeypot) in order, for example, to avoid security problems for the target system (e.g., due to passwords becoming known).

Exemplary embodiment 9 is a honeypot generation device configured to perform the method according to one of exemplary embodiments 1 to 8.

Exemplary embodiment 10 is a computer program comprising commands that, when executed by a processor, cause the processor to perform a method according to one of exemplary embodiments 1 to 9.

Exemplary embodiment 11 is a computer-readable medium storing commands that, when executed by a processor, cause the processor to perform a method according to one of exemplary embodiments 1 to 9.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a computer network, according to an example embodiment of the present invention.

FIG. 2 illustrates the generation of a honeypot according to one example embodiment of the present invention.

FIG. 3 shows a flowchart that represents a method for generating a honeypot according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

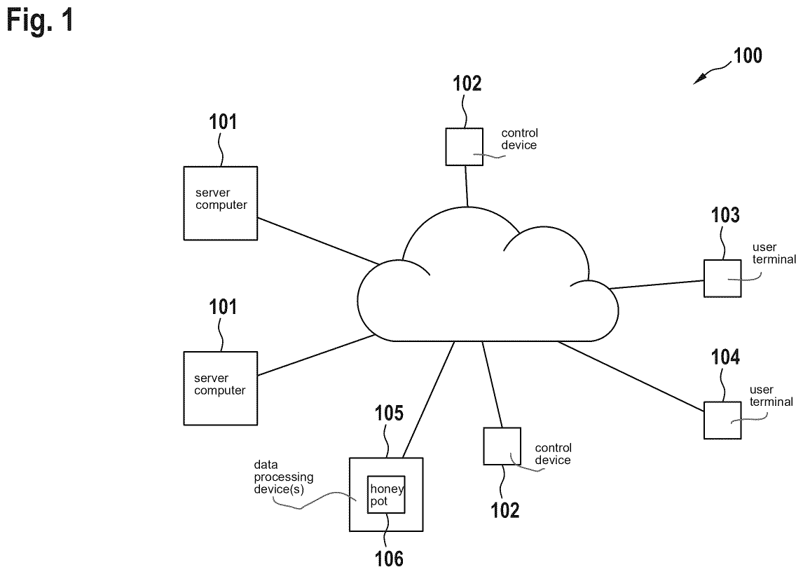

FIG. 1 shows a computer network 100. The computer network 100 contains a plurality of data processing devices 101-105 interconnected by communication links. The data processing devices 101-105 include, e.g., server computers 101 and control devices 102 along with user terminals 103, 104.

Server computers 101 provide various services, such as Internet sites, banking portals, etc. A control device 102 is, e.g., a control device for a robot device, such as a control device in an autonomous vehicle. The server computers 101 and control devices 102 thus fulfill different tasks and typically a server computer 101 or a control device 102 can be accessed from a user terminal 103, 104. This is particularly the case if a server computer 101 offers a functionality to a user, such as a banking portal. However, a control device 102 can also allow access from outside (e.g., so that it can be configured). Depending on the task of a server computer 101 or control device 102, they can store security-related data and execute security-related tasks. Accordingly, they must be protected against attackers. For example, an attacker using one of the user terminals 104 could, through a successful attack, gain possession of confidential data (such as keys), manipulate accounts or even manipulate a control device 102 in such a way that an accident occurs.

A security measure against such attacks is a so-called honeypot 106 (which is implemented by one of the data processing devices 105). It seemingly provides a functionality and thus serves as bait to attract potential attackers. However, it is isolated from confidential information or critical functionality so that attacks on it take place in a controlled environment and the risk of compromising the actual functionality is minimized. It thus makes it possible to gain knowledge about attacks on a target system (e.g., one of the server computers 101 or one of the control devices 102), and thus the threat landscape, to which the implementation of suitable measures on the target system can respond, without these attacks endangering the target system.

A honeypot is thus a deception system that imitates a target system (also referred to as a “valuable target”). It entices attackers to attack the honeypot and expose attack vectors that target the actual, valuable target. For example, a web server (or the web server software) is a popular option that is imitated by a honeypot. Since web servers make up a large portion of the public Internet, it is important to continuously monitor for threats targeting them.

Honeypots are of interest especially to the automotive industry since there are hardly any data on actual attacks. According to various embodiments, the honeypot 106 can thus, for example, be implemented in a vehicle. The computer network 100 can then at least partially include an internal network of the vehicle (but also a network that establishes connectivity to the vehicle from the outside, such as a mobile radio network).

However, when manually configuring a honeypot, implementing a suitable honeypot for the specific need and the corresponding target system requires a lot of manual work by a corresponding expert: In order to imitate a target system running, for example, a Debian operating system, a honeypot developer must manually implement shell commands, including the interaction with the file system, that reflect the functionality of Debian. Developers therefore often implement only a subset of the commands that are expected to be used by attackers. In order to imitate another operating system such as Windows or Ubuntu, a developer must manually re-implement all command line interactions in order to imitate the desired operating system.

According to various embodiments, an approach is therefore provided that makes it possible to automatically adopt arbitrary implementations and versions of various interfaces (in particular operating system interfaces such as a command line interface) for a honeypot implementation by means of learned state machines (i.e., to automatically generate the honeypot such that it implements the interfaces according to the learned state machine).

The state machine of a program or software (in particular of its interfaces) can be learned from well-formulated inputs (i.e., in general, messages to the interface) by observing the resulting output (i.e., responses). Learning state machines can be divided into two dimensions: activity and visibility. For activity, there are active and passive learning algorithms. While passive algorithms only learn from observing the data traffic, e.g., from the recorded data traffic between a client and a server, active algorithms can make new queries, e.g., to the server, in order to discover even more states. In order to ensure visibility, learning algorithms work in a black box, gray box, or white box setting. In a white box setting, everything within the software and the code is visible to the algorithms. Learning a state machine can thus work with additional static analysis tools. In a black box setting, only the messages to the learning target can be created and the responses of the learning target can be observed without the internals of the software being known in any way. In a gray-box setting, a lightweight instrumentation is usually compiled into the learning target in order to additionally obtain some coverage information at runtime and to facilitate state estimation.

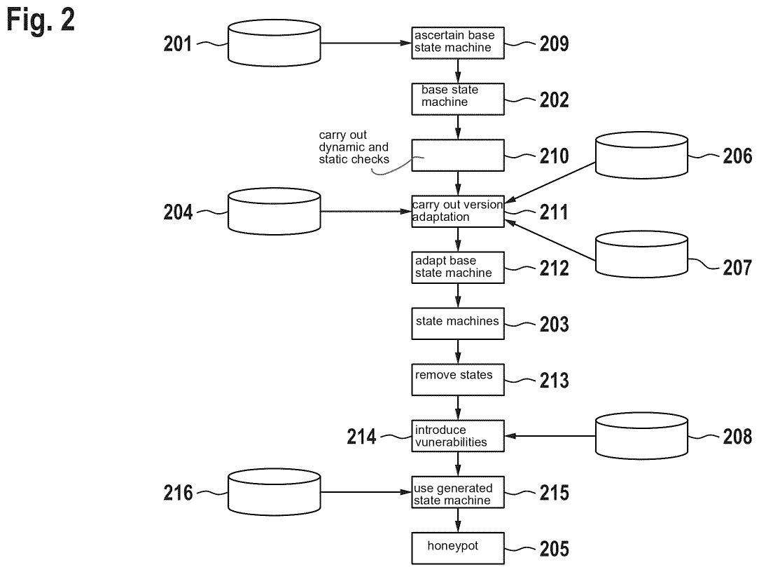

FIG. 2 illustrates the generation of a honeypot according to one embodiment.

The following components are involved:

Non-critical example target system 201: States of a base state machine 202, which is then adapted to form a state machine 203 for the particular target system 204, are learned by probing one or more non-critical example target systems 201, which, for example, use the operating system that is to be simulated by the honeypot 205 to be generated (but possibly not in the correct version).

State machines 203 for the target system 204: The derived state machine that models a complex system such as the operating system of the target system 204. Alternatively, the operating system can also be estimated as a state machine of state machines.

Target system 204 or database with information about the target system 204: The base state machine 202 is adapted to the target system 204 that the honeypot 205 is to imitate.

Database with honeypot records (e.g., logs) 206: This database contains information about previous honeypot findings (i.e., in particular, about attacks that have been conducted on other honeypots). From these findings, a prioritization of components and functionalities that are to be simulated by the honeypot can be derived.

Database with traces of attacks 207: This database stores logs and traces of actual attacks. These logs and traces can also be used to prioritize components and functionalities that are to be simulated by the honeypot.

Database of security gaps 208: A database with vulnerabilities for all types of operating systems such as the National Vulnerability Database (NVD).

Ascertaining a configuration for the honeypot (and, where applicable, also selecting an architecture, which is to be configured, for the honeypot) is carried out by a honeypot generation device (or honeypot configuration device), which corresponds, for example, to one of the user terminals 104 (e.g., a computer with which a user (such as a system administrator) configures the honeypot 106 and instructs the data processing device 105 to provide the thus configured honeypot 106). The here-described methods for generating a honeypot are thus, for example, performed by such a honeypot generation device (for example, automatically).

For example, the following steps are performed.

In 209, the base state machine 202 is ascertained on the basis of the non-critical example target system 201 (or a plurality thereof) (e.g., by observing responses of the non-critical example target system 201 to messages that (e.g., the honeypot generation device) sends to the example target system 201).

In 210, dynamic tests and static checks are carried out in order to check whether the base state machine 202 (or a plurality of such base state machines 202, e.g., for a plurality of example target systems 201 or a plurality of components) functions correctly, i.e., for example, models a corresponding complex system reliably and convincingly.

In 211, a version adaptation of a corresponding (e.g., appropriately selected) base state machine 202 is carried out on the basis of the information about the target system 204.

Prioritization (e.g., by means of a weighting mechanism) in the database with honeypot records 206 and on the basis of the database with traces of attacks 207 can be used to sort system components and to decide which components are simulated in the honeypot 205. Since it is much more difficult to learn a machine for an entire system or a machine of a machine, this prioritization makes it possible to reduce the effort by selecting which components to include, e.g., which rarely used components to include. This also makes it possible to use resources, e.g., in the form of computing power, specifically for learning more detailed versions of certain components instead of less important components.

In 212, since the base state machine 202 is adapted on the basis of a critical target system, sensitive (e.g., confidential or brand-damaging) data are removed. The result is the version-adapted state machine 203 (filtered with regard to sensitive data).

In 213, states are removed from the version-adapted state machine 203 in order to break chains of states that make it possible to exploit (known) vulnerabilities, i.e., malicious states. State transitions to such malicious states can also be removed. For example, states that relate to communication with a third party (e.g., when communication is carried out with a third-party system) are removed. This can prevent an attacker from attacking third parties via the honeypot 205.

This filtering can also be performed (at least partially) before the version adaptation.

In 214, vulnerabilities are (optionally) introduced: In order to further entice attackers to examine the honeypot 205, selected known vulnerabilities can be incorporated into the version-adapted state machine 213 (filtered with regard to sensitive data). Since a state machine is not an actual operating system (and since the version-adapted state machine 213 has been filtered), this does not entail any additional risks.

In 215, the state machine thus generated (i.e., the version-adapted state machine 203 processed as described above) is used in the honeypot 205, e.g., in a container, to imitate the target system 204, e.g., its complex operating system environment such as a system shell, in order to collect data about the approach of attackers against critical systems. For this purpose, the generated state machine is inserted, for example, into a honeypot framework that provides the honeypot 205, wherein even further (e.g., user-defined) configuration data 216 can be taken into account. The state machine simulates the complex system that the honeypot 205 imitates.

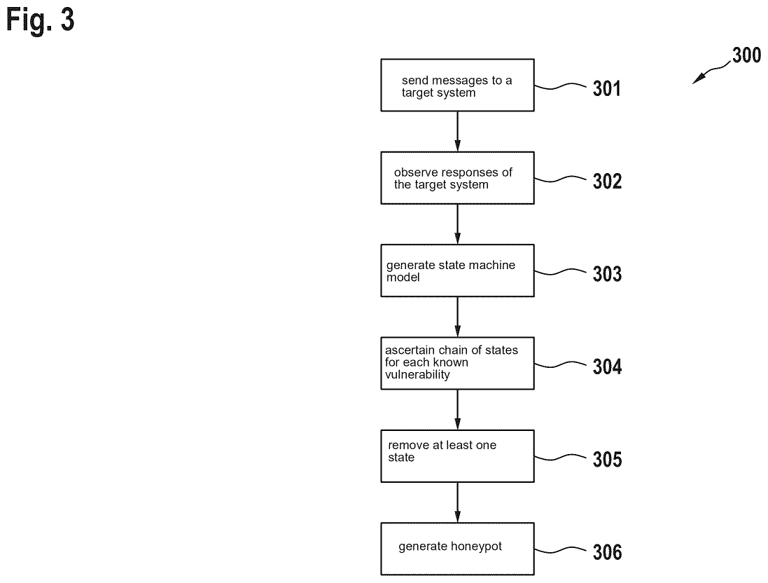

In summary, according to various embodiments, a method is provided as shown in FIG. 3.

FIG. 3 shows a flowchart 300 that represents a method for generating a honeypot according to one embodiment.

In 301, messages (shell commands, network packets, application-specific requests, etc.) are sent to a target system.

In 302, responses of the target system to the messages are observed.

In 303, according to the observed responses of the target system, a state machine model is generated for one or more interfaces of the target system (command line interface, network interface, APIs . . . ) (i.e., a state machine that models the (or the behavior of) one or more interfaces).

In 304, for each one or more known vulnerabilities, a chain of states of the state machine model is ascertained that, when followed, makes it possible to exploit the vulnerability.

In 305, for each of the one or more vulnerabilities, at least one state of the chain is removed from the state machine model (i.e., states of the chains that break the chain are ascertained and removed, e.g., as far back as possible in the chain).

In 306, a honeypot that responds to messages according to the state machine model (as resulting from 305) is generated.

In other words, according to various embodiments, a state machine for one or more components (operating systems, software programs) of a target system (and thus possibly a system with high complexity) is ascertained and used as a basis for the automatic generation of a honeypot. For example, one or more state machines of system environments, e.g., a command line interface of an operating system (OS), are estimated. One or more resulting (estimated) state machines can then be used for one or more interactive honeypots. Porting and adapting these estimated state machines so that they appear to have specific operating system versions or system versions can be carried out automatically

The method of FIG. 3 can be performed by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the particular functions described in more detail herein may also be understood as a data processing unit or logic circuit assembly. One or more of the method steps described in detail here can be executed (e.g. implemented) by a data processing unit by means of one or more special functions that are performed by the data processing unit.

The method is therefore in particular computer-implemented according to various embodiments.

1-11. (canceled)

12. A method for generating a honeypot, comprising the following steps:
sending messages to a target system;
observing responses of the target system to the messages;
generating, according to the observed responses of the target system, a state machine model for one or more interfaces of the target system;
ascertaining, for each one or more known vulnerabilities, a corresponding chain of states of the state machine model that, when followed, makes it possible to exploit the vulnerability;
removing, for each of the one or more vulnerabilities, at least one state of the corresponding chain from the state machine model; and
generating a honeypot that responds to messages according to the state machine model.

13. The method according to claim 12, wherein, for each of the one or more vulnerabilities, a state is ascertained in the corresponding chain of states and removed from the state machine model, which prevents the vulnerability from being exploited, wherein a state that is as far back as possible in the chain of states, but, upon reaching of which, damage is not yet caused, is ascertained as the state.

14. The method according to claim 12, wherein, for each of the one or more vulnerabilities, a state upon reaching of which communication with a third-party system is carried out is ascertained in the corresponding chain of states and removed from the state machine model.

15. The method according to claim 12, wherein the state machine model is generated by adapting a previously generated other state machine model for another target system according to the observed responses of the target system.

16. The method according to claim 15, wherein the other state machine model is generated by sending the requests and/or other requests to the other target system, observing responses of the other target system to the requests or the other requests, and generating the other state machine model according to the observed responses of the other target system.

17. The method according to claim 15, wherein the adapting of the other state machine model includes adapting, according to the observed responses of the target system, a version of the one or more interfaces whose behavior is modeled by the other state machine model.

18. The method according to claim 15, wherein the other state machine model is selected from a set of other state machine models for the other target system or one or more other target systems, based on a check as to whether the other state machine model fulfills functions required for imitating the target system.

19. The method according to claim 12, wherein, when generating the state machine model, information about the target system that is to be kept confidential according to a confidentiality criterion is removed from the state machine model.

20. A honeypot generation device configured to generate a honeypot, the honeypot generation device configured to:
send messages to a target system;
observe responses of the target system to the messages;
generate, according to the observed responses of the target system, a state machine model for one or more interfaces of the target system;
ascertain, for each one or more known vulnerabilities, a corresponding chain of states of the state machine model that, when followed, makes it possible to exploit the vulnerability;
remove, for each of the one or more vulnerabilities, at least one state of the corresponding chain from the state machine model; and
generate a honeypot that responds to messages according to the state machine model.

21. A non-transitory computer-readable medium on which are stored commands for generating a honeypot, the commands, when executed by processor, causing the processor to perform the following steps:
sending messages to a target system;
observing responses of the target system to the messages;
generating, according to the observed responses of the target system, a state machine model for one or more interfaces of the target system;
ascertaining, for each one or more known vulnerabilities, a corresponding chain of states of the state machine model that, when followed, makes it possible to exploit the vulnerability;
removing, for each of the one or more vulnerabilities, at least one state of the corresponding chain from the state machine model; and
generating a honeypot that responds to messages according to the state machine model.
